(19) United States
(12) Patent Application Publication
(10) Pub. No.: US 2025/0327731 A1
(43) Pub. Date: Oct. 23, 2025

(54) MEASURING ASSEMBLIES AND METHOD FOR DETERMINING INTERFACIAL TENSION

(71) Applicant: Helmholtz-Zentrum Dresden-Rossendorf e.V., Dresden (DE)

(72) Inventors: Zhe Lei, Dresden (DE); Peggy Jähnigen, Dresden (DE); Kerstin Eckert, Dresden (DE)

(21) Appl. No.: 19/180,730

(22) Filed: Apr. 16, 2025

(30) Foreign Application Priority Data
Apr. 17, 2024 (DE) 102024110779.0

(51) Int. Cl. G01N 13/02

(52) U.S. Cl. CPC G01N 13/02; G01N 2013/0283

(57) ABSTRACT

A measuring assembly for determining interfacial tension includes a vessel with a chamber for receiving a carrier liquid. A sample liquid is supplied to the chamber drop by drop via a supply device. A magnetic field source generates an inhomogeneous magnetic field with a vertical magnetic field gradient in the chamber. A measuring device detects at least one section of a contour of a drop of the sample liquid formed in the chamber during operation of the measuring assembly.

### TECHNICAL FIELD

The present application relates to measuring assemblies and a method for determining the interfacial tension between two liquids. In particular, the present application relates to an optical tensiometer which optically detects the contour of a drop of a liquid.

### BACKGROUND

Tensiometers for determining surface tension or interfacial tension can be used to monitor industrial processes and determine the flow behavior of liquids. Findings about the flow behavior can be incorporated into the design and development of products, technical processes and industrial plants. Optical tensiometers for drop contour analysis measure the shape of a drop of a liquid and infer the surface or interfacial tension from shape parameters.

In contact angle measuring, a drop of a liquid to be characterized is placed on a solid surface. The contact angle between the drop and the solid surface is determined using an optical method, and the surface tension of the liquid to be characterized is established from the contact angle using Young's equation.

The captive bubble method creates a gas bubble in the liquid to be characterized, which adheres to the surface of a solid immersed in the liquid. Once again, the contact angle between the drop and the solid surface is determined using an optical method, and, using Young's equation, the surface tension of the liquid to be characterized is inferred from the contact angle.

In the pendant drop method, the shape of a drop of the liquid to be characterized hanging from a capillary is detected optically. The Young-Laplace equation can be used to infer the interfacial tension from the position of characteristic points on the drop surface and/or the size of the drop breaking off.

The sessile drop method detects the shape of a drop of the liquid to be characterized placed on a semi-circular, solid base. The surface tension is inferred using the Young-Laplace equation.

For the spinning drop method, a drop of a sample liquid is added to a heavier phase in a horizontally mounted, cylindrical cannula. When the cannula is rotated around its longitudinal axis, the contour of the drop changes. The interfacial tension between the sample liquid and the heavier phase can be inferred from the change in contour using the Vonnegut equation and the Young-Laplace equation.

In the publications Sudo, S. Hashimoto, H., Ikeda, A: Measurements of the Surface Tension of a Magnetic Fluid and Interfacial Phenomena; JSME international journal (1989), Series II, Vol. 1, pp. 47-51, Flament C. et al.: Measurements of ferrofluid surface tension in confined geometry; Phys. Rev. E (1996), Vol. 53, 4801, and Hayakawa, M. et al.: Effect of moderate magnetic fields on the surface tension of aqueous liquids: a reliable assessment; RSC Adv., 2019, 9, 10030-100033, the effect of a homogeneous magnetic field on the shape of a drop of liquid was examined.

### SUMMARY

The present application is based on the object of determining the interfacial tension between two liquids in a simple manner.

This object is achieved with the measuring assembly and with the method described herein.

The following figures show embodiments of the measuring assemblies according to the invention or the method according to the invention. The elements and structures shown in the figures are not necessarily depicted true to scale to one another. Identical reference numerals refer to identical or corresponding elements and structures.

### BRIEF DESCRIPTION OF THE DRAWINGS

FIG. 1 shows a schematic view of a measuring assembly for determining the interfacial tension between a carrier liquid and a sample liquid according to one embodiment.

FIG. 2 shows the contour of a drop of the sample liquid during operation of the measuring assembly of FIG. 1 during measurement according to one embodiment.

FIG. 3 shows a perspective view of a vessel, a supply device and a magnetic field source of the measuring assembly according to FIG. 1.

FIG. 4 shows a perspective view of a detail of the measuring assembly according to FIG. 1.

FIG. 5 shows a schematic view of a measuring assembly for determining the interfacial tension with a dosing pump for supplying the sample liquid drop by drop and with an optical apparatus for determining the drop shape according to one embodiment.

FIG. 6 shows a schematic perspective view of a measuring assembly for determining the interfacial tension by means of sensors/electrodes for impedance/resistance measurement on the wall of a cuvette with a rectangular base area according to one embodiment.

FIG. 7 shows a schematic perspective view of a measuring assembly for determining the interfacial tension by means of sensors/electrodes for impedance/resistance measurement on the wall of a cuvette with a circular base area according to one embodiment.

FIG. 8A to FIG. 8D show schematic views of a chamber filled with a carrier liquid of a measuring assembly in different phases of a method for determining the interfacial tension according to one embodiment.

FIG. 9 shows a schematic view of a process line with a measuring assembly arranged within a bypass for determining the interfacial tension according to another embodiment.

### DETAILED DESCRIPTION

In the following detailed description, reference is made to the accompanying drawings. The accompanying drawings form part of the description and show, for illustrative purposes, specific embodiments which can be used for producing the invention. Directional terminology such as “top”, “bottom”, “front”, “rear”, “anterior”, “posterior”, etc., is used with reference to the orientation of the figure(s) described. Since components of the embodiments can be positioned in a number of different orientations, the directional terminology is for explanatory purposes only and is not to be understood to be restrictive in any way. In addition to the embodiments sketched, there are other embodiments. Structural or logical changes can be made to the embodiments depicted in the figures and/or described in the following text, without deviating from the subject matter claimed. Features of the embodiments described can be combined with one another, unless expressly or inherently indicated otherwise. Vertical axes and directions are aligned parallel or approximately parallel to the direction of the gravitational force.

One aspect of the present disclosure relates to a measuring assembly for determining the interfacial tension of a sample liquid. The measuring assembly includes a vessel with a chamber for receiving a carrier liquid, a supply device, a magnetic field source, and a measuring device.

The vessel, for example, is a cuvette with plane-parallel side surfaces suitable for optical examination of the content. The material of at least two opposite side surfaces is transparent for the wavelength range used for the optical examination. The transparent material is glass, e.g., quartz glass, or a transparent plastic. Apart from an inlet opening, the cuvette can be closed and sealed or open.

The supply device is configured to supply the sample liquid drop by drop into the chamber. For example, the supply device comprises a cannula suitable for connection to a dosing pump with an outlet opening on a free end inside the chamber. The supply device can have a guide that fixes the free end of the cannula at a working position in the chamber of the cuvette.

The magnetic field source is configured to generate an inhomogeneous magnetic field with a vertical magnetic field gradient in the chamber. The magnetic field source, for example, is an electromagnet or a permanent magnet with a fixed positional relationship to the vessel. The magnetic field source can be permanently connected to the vessel in a force-locking manner, or the vessel and the magnetic field source can be temporarily connected to one another in a force-locking manner.

The magnetic field source can be arranged above the chamber if the density ρ0 of the sample liquid is lower than the density pf of the carrier liquid. The magnetic field source can be arranged below the chamber if the density ρ0 of the sample liquid is higher than the density pf of the carrier liquid.

The measuring device is configured to detect at least one section of a contour of a drop of the sample liquid formed in the chamber during operation of the measuring assembly. The drop is at least approximately point-symmetrical in the horizontal cross-sectional planes. The contour is the parallel projection of the largest vertical cross-sectional area of the drop onto a vertical plane. The measuring device can detect one or more sections of the contour or the entire contour of the drop in one plane or several non-parallel planes.

To operate the measuring assembly, the vessel is filled with a paramagnetic carrier liquid. At least one drop of the sample liquid is injected into the carrier liquid by the supply device. If several drops are injected in succession, the injected drops coagulate into a single drop.

The position of the drop on a vertical axis parallel to the direction of the gravitational force results from the equilibrium condition for weight force, buoyancy force and magnetic gradient force.

In the inhomogeneous magnetic field, the drop visibly deforms in its contour, with the shape of the drop depending on the local magnetic field strengths and material properties of the carrier liquid and the sample liquid. In this process, the side of the drop that is exposed to the stronger magnetic pressure flattens out more than the side that is exposed to the weaker magnetic pressure. Depending on the position of the drop in relation to the magnetic field source, the upper side or the bottom side can be exposed to the stronger magnetic pressure.

The measuring device detects at least one section of the contour and the position of the drop relative to the magnetic field. The interfacial tension between the carrier liquid and the sample liquid can be inferred from the contour, the local magnetic field strength and the material properties of the carrier liquid and the sample liquid.

The measuring assembly makes it easy to establish the interfacial tension. The contour of the drop can be detected in a state in which the drop is completely enclosed by the carrier liquid and is not directly adjacent to a third, solid phase. The influence of such a third phase on the measurement result is eliminated. There are no or hardly any measurement errors due to temperature changes, vibrations and air movement, as is often observed for other optical tensiometers.

According to one embodiment, the measuring assembly has an evaluation unit which is configured to determine significant parameters of the contour (contour parameters) from the sections of the contour of the drop detected by the measuring device.

Such significant contour parameters, for example, are the maximum vertical extension of the drop, the vertical distance between a geometric upper edge and a geometric lower edge of the drop, the vertical extension of the drop along the vertical axis of symmetry, the maximum horizontal diameter of the drop and local curvatures between the drop and the surrounding liquid at selected points, e.g., in the area of the vertical axis of symmetry and in the plane of the maximum horizontal extension.

According to one embodiment, the evaluation unit is configured to determine the interfacial tension between the drop and the carrier liquid from the significant parameters and magnetic field strengths acting locally on the drop.

For example, the interfacial tension can be calculated from the significant parameters with the aid of the Young-Laplace equation, taking into account the magnetic pressure acting in the vertical direction, the susceptibility of the carrier liquid, and the densities of the carrier liquid and the sample liquid.

According to one embodiment, an outlet opening of the supply device positioned inside the chamber is closed off with an open capillary. The diameter of the capillary is sufficiently narrow so that the amount of sample liquid required to form a drop with a small volume completely fills a longitudinal section of the capillary.

According to one embodiment, the measuring assembly comprises a dosing pump, wherein the dosing pump is connected to an inlet opening of the supply device, and the dosing pump is configured to dispense the sample liquid drop by drop into the chamber of the vessel.

According to one embodiment, the measuring device has a radiation source for electromagnetic waves and a radiation sensor for the electromagnetic waves emitted by the radiation source, wherein the vessel is arranged within a beam path between the radiation source and the radiation sensor.

The radiation source emits measuring radiation. The radiation sensor detects the part of the measuring radiation passing through the vessel with spatial resolution. For example, the measuring radiation is broadband or narrowband radiation in the visible wavelength range, in the infrared range and/or in the ultraviolet range. The radiation sensor can have a camera with a high-resolution image sensor, e.g., a far-field optical microscope. The image sensor can be configured to detect the sections of the contour in relation to a horizontal plane from at least one side. According to another example, the radiation source is an X-ray source, and the radiation sensor is an X-ray image sensor.

According to one embodiment, the measuring device has a plurality of electrodes arranged on the vessel and an impedance measuring device, wherein the impedance measuring device is configured to determine electrical impedances between two of the electrodes in each case.

The electrodes can be attached to the inner surface of the chamber or embedded in the wall of the chamber. The electrodes can be arranged in two or more rows, wherein electrodes arranged in the same row are arranged at the same height above the base area of the chamber along the circumference of the chamber.

The impedance measuring device can transmit a periodic signal as an excitation signal to at least one portion of the electrodes and determine the complex impedance between two electrodes arranged at different points on the chamber wall. Alternatively or additionally, the impedance measuring device can have a resistance measuring device, wherein the resistance measuring device is configured to determine the electrical resistance between two of the electrodes in each case.

For each electrode, an impedance measurement and/or resistance measurement can be carried out with exactly one additional electrode, with several additional electrodes, or with all additional electrodes.

Due to the different conductivities and/or different dielectric properties of the carrier liquid and the sample liquid, the impedances between the electrodes change as a function of the shape and size of the drop. Different shapes and sizes of the drop are reflected in different signatures of the impedances or resistance values established.

The impedances or electrical resistances between each pair of electrodes provide information about the contour of the drop. Based on a tomographic reconstruction, the local curvatures on the upper side and bottom side of the drop can be specified, and the interfacial tension can be established using the Young-Laplace equation.

According to one embodiment, an apparatus for processing or using a process liquid includes the measuring assembly, wherein the process liquid as the carrier liquid can be supplied to and discharged from the measuring assembly permanently, at predefined time intervals or by user intervention. A controllable process device of the apparatus is controllable as a function of the interfacial tension established by the measuring assembly.

The process liquid can be a liquid that is a subject of the process or an auxiliary liquid that contributes to the process but is not consumed. The measuring assembly enables continuous monitoring of a process acting on the carrier liquid or dependent on the interfacial tension of the carrier liquid during operation.

Another aspect of the present disclosure relates to a measuring assembly for determining the interfacial tension of a sample liquid in an operational state. Such a measuring assembly comprises a paramagnetic carrier liquid in a chamber of a vessel, a drop of a sample liquid in the carrier liquid, a magnetic field source, and a measuring device. The magnetic field source is configured to generate an inhomogeneous magnetic field with a vertical magnetic field gradient in the chamber. The sample liquid is paramagnetic to a lesser degree than the carrier liquid. The sample liquid and the carrier liquid are immiscible with one another. The measuring device is configured to detect at least one section of a contour of the drop.

According to one embodiment, the sample liquid contains a diamagnetic liquid or consists, apart from impurities, entirely of a diamagnetic liquid.

According to one embodiment, the carrier liquid is an aqueous solution and the sample liquid is a hydrophobic liquid, or the sample liquid is an aqueous solution and the carrier liquid is a hydrophobic liquid. The carrier liquid and the sample liquid can have different densities.

According to one embodiment, the carrier liquid is an aqueous solution containing a salt of a rare earth or several salts of rare earths. The anion portion of the dissolved salt or salts contains, for example, chloride ions, nitrate anions, sulfate anions, hydrogen sulfate anions, phosphate anions, hydrogen phosphate anions, dihydrogen phosphate anions, carbonate anions and/or hydrogen carbonate anions.

The cation portion of the dissolved salt or salts contains, for example, dysprosium(III) ions, holmium(III) ions, erbium(III) ions and/or gadolinium(III) ions. The carrier liquid can be or contain a dysprosium(III) chloride solution (DyCl₃), for example.

The sample liquid, for example, is a diamagnetic oil, e.g., a paraffin or naphtene. The sample liquid can be selected from the following group of organic solutions: carbon tetrachloride, chlorobenzene, cyclohexane, heptane, hexane, pentane, toluene and triethyl amine.

According to another example, the carrier liquid is a superparamagnetic liquid, e.g., a ferrofluid, and the sample liquid is a liquid elemental metal, e.g., mercury, or a liquid metal alloy, e.g., galinstan.

Another aspect of the present disclosure relates to a method for determining interfacial tension. The method comprises generating a magnetic field, wherein the magnetic field in a chamber of a vessel has a vertical magnetic field gradient, producing a drop of a sample liquid in the chamber filled with a carrier liquid, wherein the sample liquid is paramagnetic to a lesser degree than the carrier liquid, and wherein the sample liquid and the carrier liquid are immiscible with one another, and detecting significant parameters of the contour of the drop. The sample liquid can be diamagnetic.

According to one embodiment, the method also comprises determining the interfacial tension from the significant parameters and magnetic field strengths acting locally on the drop.

According to one embodiment, the drop is produced by first dispensing a small volume of the sample liquid into the chamber and forming a precursor drop, further dispensing sample liquid into the chamber and coagulating with the precursor drop until the drop resulting from the precursor drop reaches a size at which the contour of the drop fulfills a predetermined criterion.

The predetermined criterion can be a maximum difference in height of the flat side of the drop across a horizontal minimum surface. With a sufficiently flat side of the drop, the significant parameters of the contour of the drop can be determined with high precision.

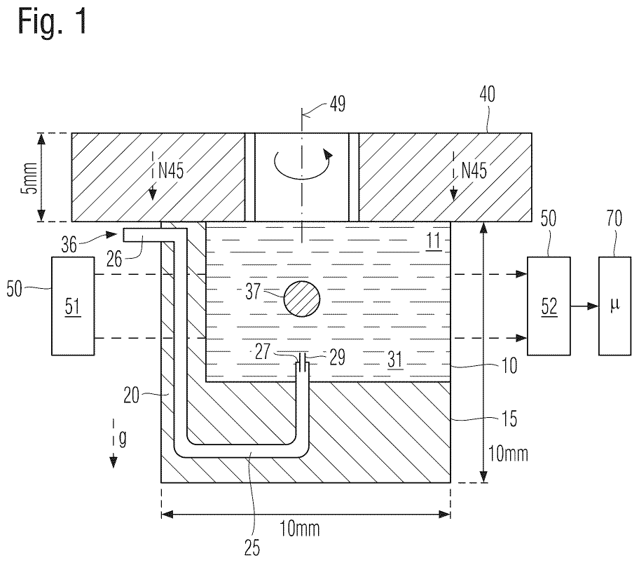

FIG. 1 shows a measuring assembly with a cuvette 15 as a vessel 10 with a chamber 11 for receiving a carrier liquid 31. The cuvette 15 has a rectangular base plate and two pairs of plane-parallel side surfaces made of transparent plastic. The transparent plastic is a polyimide, polytetrafluoroethylene (PTFE) or polymethyl methacrylate (acrylic glass), for example. The horizontal cross-sectional area of the chamber 11 can be approximately 1 cm², e.g., within a range of 0.5 cm² to 2 cm². The height of the chamber 11 perpendicular to the base plate can be at least 0.5 cm up to 5 cm, e.g., about 1 cm.

A supply device 20 with a tubular or tube-like cavity 25 (cannula) is inserted into the cuvette 15. The supply device 20 has a connection piece 26 suitable for connection to a flexible tube or a dosing pump at an inlet opening accessible from outside the chamber 11 and an upwardly directed outlet opening 27 inside the chamber 11. The outlet opening 27 is closed off with a capillary 29. The cannula 25 extends continuously from the inlet opening to the outlet opening 27, while maintaining the same diameter. The supply device 20, for example, comprises a 3D-printed plastic part that is positively fitted into the lower part of the chamber 11.

A magnetic field source 40 of the measuring assembly comprises a ring magnet with a central opening. The ring magnet, for example, is a neodymium magnet of grade N45. The ring magnet closes off the chamber 11 upwards or rests on a lid of the cuvette 15. The longitudinal axis of the ring magnet and the longitudinal axis of the capillary 29 are coaxial and lie on the same straight line. The ring magnet generates an inhomogeneous magnetic field with a vertical magnetic field gradient in the chamber 11.

At least one part of the chamber 11 above the outlet opening of the capillary 29 is filled with a carrier liquid 31. The carrier liquid 31 contains a paramagnetic phase with a magnetic susceptibility X and a density pf. The paramagnetic phase, for example, can contain or consist of a paramagnetic salt in an aqueous solution, several paramagnetic salts in an aqueous solution, an ionic liquid, an organic solvent and/or a silicon-based oil.

A sample liquid 36 is supplied drop by drop to the chamber 11 via the supply device 20. The sample liquid 36 and the carrier liquid 31 are immiscible with one another. The sample liquid 36 emerging from the capillary 29 forms one or more drops that detach(es) from the capillary 29 and, oscillating along the vertical axis, reach(es) an end position above the capillary 29 and at a distance from the capillary 29 and from the magnetic field source 40 after some time. In this process, several drops coagulate into a single drop 37. The shape of the drop 37 at the end position depends on the susceptibility X and the density pf of the carrier liquid, the density ρ0 of the sample liquid, the magnetic field densities on the lower and upper edges of the drop 37 and the interfacial tension between the carrier liquid 31 and the sample liquid 36.

A measuring device 50 comprises a radiation source 51 on a first side of the cuvette 15 and a radiation sensor 52 on the side of the cuvette 15 opposite the radiation source 51. The radiation sensor 52 is an image sensor, for example.

An evaluation unit 70 is connected to the measuring device 50 by data technology and receives image data that describes a contour of the drop 37 from the measuring device 50. The evaluation unit 70 determines significant parameters of the contour from the received image data, for example, the local curvature on the geometric upper edge κ_{Top} of the drop 37 and the local curvature κ_{Bot} on the geometric lower edge of the drop 37. The geometric upper edge can be determined by the highest point of the drop surface, the geometric lower edge by the lowest point relative to the earth surface of the drop surface.

From the significant parameters, the difference X of the magnetic susceptibilities of the sample liquid and the carrier liquid, the density pf of the carrier liquid, the density ρ0 of the sample liquid, the magnetic flux densities B_{Top} and B_{BOt} on the upper and lower edges of the drop 37 and the local curvatures κ_{Top} and κ_{Bot} on the geometric upper and lower edges of the drop 37, the evaluation unit 70 calculates the interfacial tension a between the sample liquid 36 and the carrier liquid 31, e.g., according to equation #1:

$$σ = \frac{1}{2 ( {κ}_{Bot} - {κ}_{Top} )} \cdot [ \frac{( {B}_{Top}^{2} - {B}_{Bot}^{2} ) \cdot χ \cdot c}{2 {μ}_{0}} + ( {ρ}_{o} - {ρ}_{f} ) \cdot gh ] \qquad ( 1 )$$

wherein μ₀ is the vacuum magnetic permeability, g is the free fall acceleration, h is the vertical distance between the upper side and the bottom side of the drop 37 or the vertical distance between the geometric upper edge and the geometric lower edge of the drop 37, and c is the molar concentration of the paramagnetic salts dissolved in the carrier liquid. For example, for an aqueous dysprosium(III) chloride solution (DyCl₃), c is the concentration of dysprosium(III) ions in water.

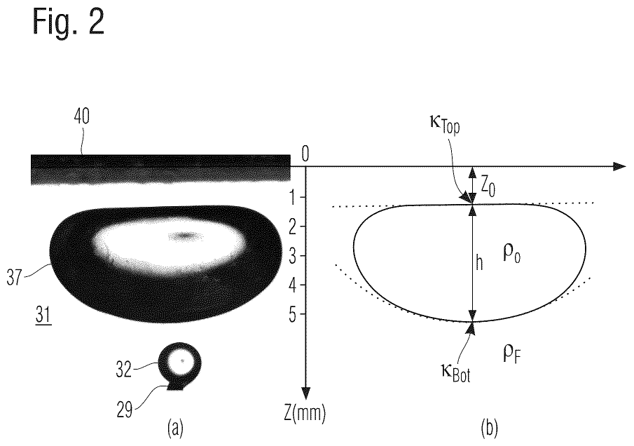

FIG. 2 shows on the left-hand side an image of a drop 37 of the process liquid 36 taken by a radiation sensor 52 configured as an image sensor. The drop 37 floats in the carrier liquid 31 at a distance z0 from the lower edge of the magnetic field source 40. The drop 37 emerges from a plurality of smaller precursor drops 32, which successively detach from the capillary 29 and coagulate into the drop 37.

In the depicted case, the upper side of the drop 37 is exposed to a stronger magnetic pressure and flattens out comparatively strongly. The bottom side of the drop 37 is exposed to a weaker magnetic pressure and the local curvature of the drop 37 is only slightly reduced.

The right-hand side of FIG. 2 shows parameters that can be obtained from the image on the left-hand side of the figure to calculate the interfacial tension σ, e.g., the local curvatures κ_{Top} and κ_{Bot} on the upper and lower edges of the drop 37. The magnetic flux densities B_{Top} and B_{Bot} on the upper and lower edges of the drop 37 can be established from the distances of the upper edge and the lower edge of the drop 37 to the lower edge of the magnetic field source 40 when the magnetic field generated by the magnetic field source 40 is known.

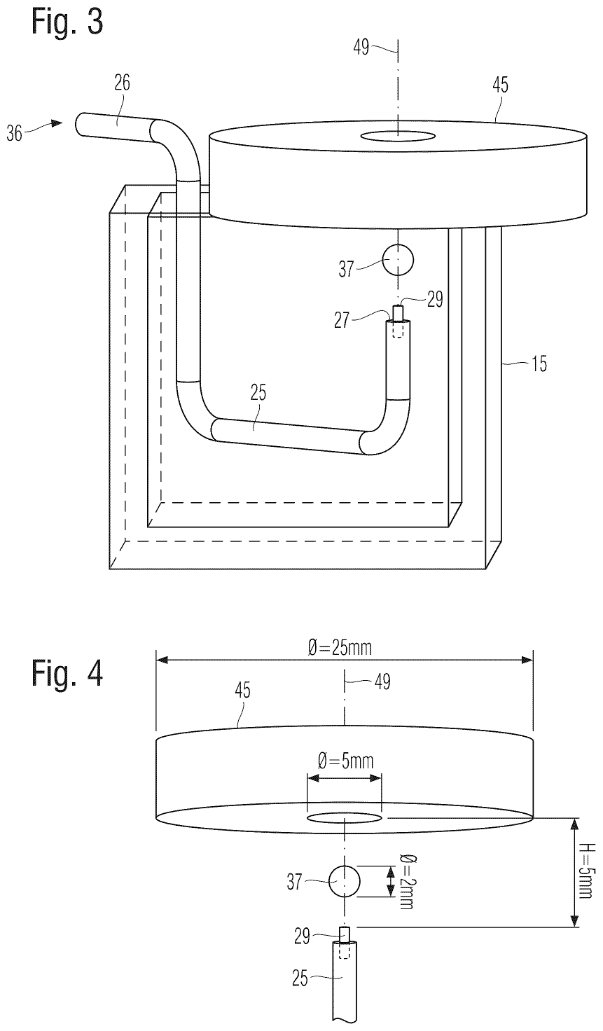

FIG. 3 shows the coaxial arrangement of the longitudinal axis of the capillary 29 and the longitudinal axis 49 of the ring magnet 45.

FIG. 4 shows typical dimensions for the outer diameter of the ring magnet 45, the diameter of the opening in the ring magnet 45, the distance between the opening of the capillary 29 and the lower edge of the ring magnet 45, and a typical hydrodynamic length of the drop 37.

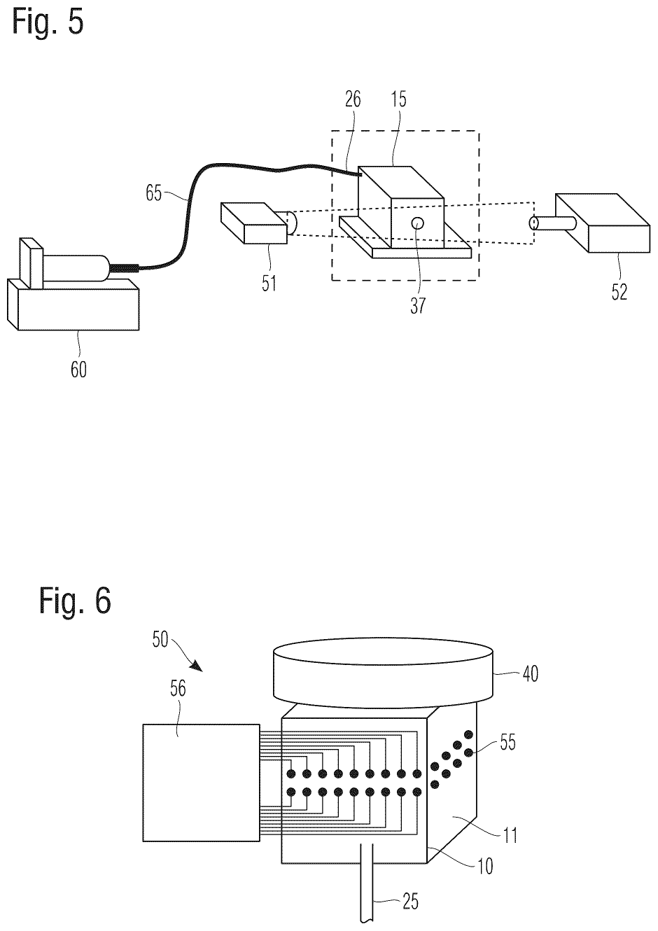

In FIG. 5, a dosing pump 60 is connected to the connection piece 26 of the supply device via a hose line 65. The cuvette 15 is arranged within the beam path between a radiation source 51 and a radiation sensor 52. The drop 37 is reproduced onto a radiation-sensitive sensor surface of the radiation sensor 52.

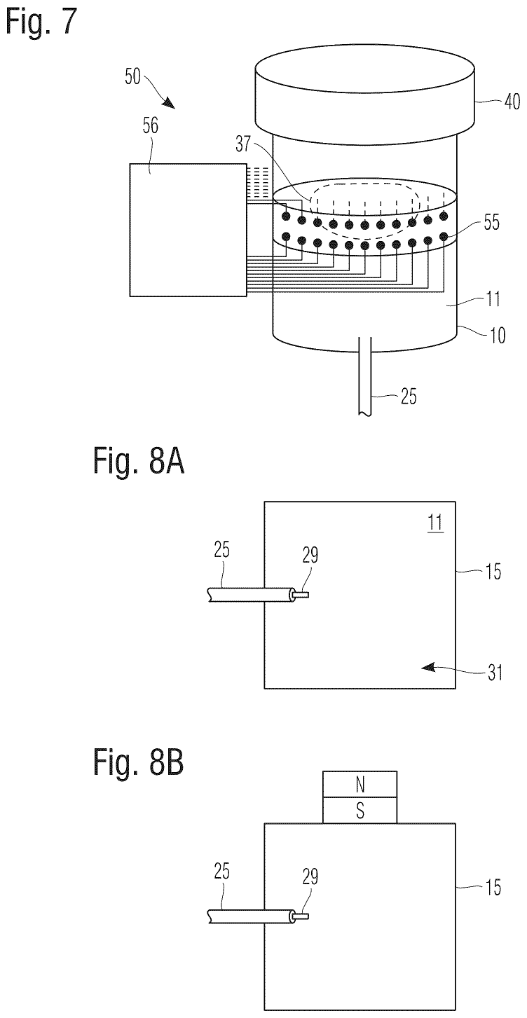

FIG. 6 and FIG. 7 each show a measuring device 50 with a plurality of electrodes 55 arranged on the vessel 10. Excitation signals can be output and/or measuring signals can be received via the electrodes 55. An impedance measuring device 56 establishes the electrical impedances between two electrodes 55 (pairs of electrodes) arranged at different points on the chamber wall from the measuring signals received from the electrodes 55.

The electrodes 55 are attached to the inner surface of the chamber 11 or embedded in the wall of the chamber 11. The electrodes 55 are arranged in at least two rows, wherein electrodes 55 arranged in the same row are arranged at the same height above the base area of the chamber 11 along the circumference of the chamber 11.

The base area of the chamber 11 in FIG. 6 is rectangular. The base area of the chamber 11 in FIG. 7 is circular.

For impedance measurement, the impedance measuring device 56 outputs a periodic excitation signal to at least one pair of electrodes and determines the complex impedance between the electrodes of a pair of electrodes. Alternatively or additionally, the impedance measuring device can determine the electrical resistance between pairs of electrodes.

For each electrode 55, an impedance measurement and/or resistance measurement can be carried out with exactly one additional electrode 55, with several additional electrodes 55, or with all additional electrodes 55. The impedances or electrical resistances between each pair of electrodes provide information about the contour of the drop 37.

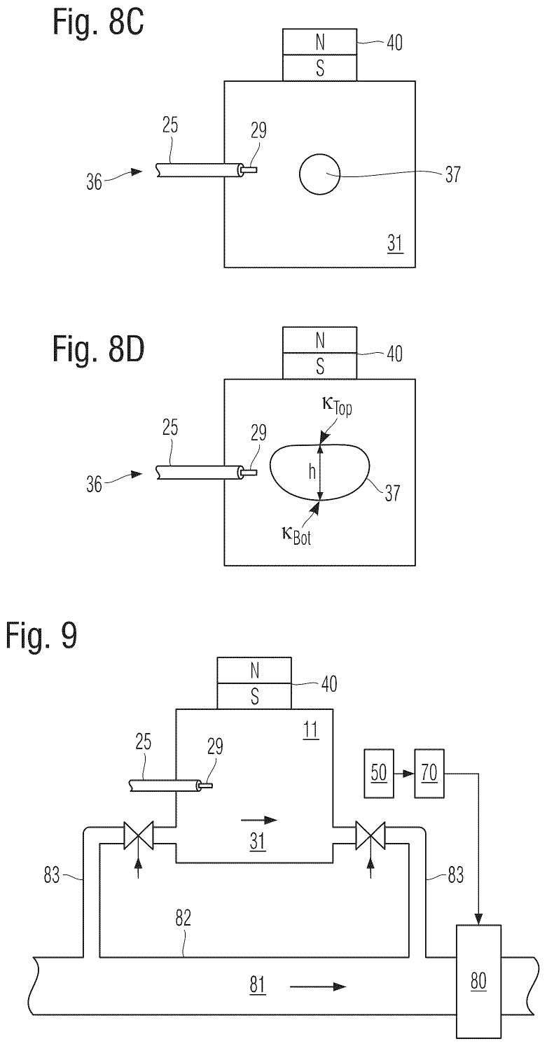

FIG. 8A to FIG. 8D show the sequence of a measurement of the interfacial tension between a carrier liquid 31 and a sample liquid based on schematic longitudinal sections through a cuvette 15.

FIG. 8A shows a cuvette 15 filled with the carrier liquid 31. FIG. 8B schematically shows the activation of a magnetic field source 40, which generates a magnetic field with a vertical magnetic field gradient in the cuvette 15. In FIG. 8C, a sample liquid 36 is dispensed into the cuvette 15 via a cannula 25 closed off with a capillary 29. The sample liquid 36 forms a drop 37. FIG. 8D shows a flattened drop 37 on the upper side oriented towards the magnetic field source 40.

FIG. 9 shows an apparatus for processing or using a process liquid 81. A line 82 supplies the process liquid 81 to a controllable process device 80. Via a bypass 83, a portion of the process liquid 81 is drained permanently, as required or at regular intervals, and supplied to the cuvette 15 of a measuring assembly described above as the carrier liquid 31. After the interfacial tension has been determined, the carrier liquid can be drained from the cuvette 15 and resupplied to the line 82, for example.

An evaluation unit 70 transmits the established interfacial tension to the controllable process device 80. The process device 80 can control a process dependent on the interfacial tension of the carrier liquid in such a way that fluctuations in the interfacial tension are at least partially compensated for, process parameters are adjusted to the most recently established interfacial tension and/or a process is terminated when the interfacial tension falls below or exceeds a predetermined value.

For example, if the line 82 transports a Dy(III) solution from which the process device 80 extracts dysprosium, then an interfacial tension measurement with a standardized oil of a known density and magnetic susceptibility provides information about how far the extraction process has already progressed.

Alternatively, the phase to be examined, e.g., an oil, can be introduced, via the inlet 29, into a chamber 15 filled with a standardized carrier liquid of a known density and a known magnetic susceptibility. The established interfacial tension provides information about the current composition of the oil phase in a reactor. In case of a rare earth extraction/stripping process, the interfacial tension can be used to infer the content of rare earths in the oil phase.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A measuring assembly for determining interfacial tension of
a sample liquid, the measuring assembly comprising:
a vessel with a chamber configured to receive a carrier liquid;
a supply device configured to supply the sample liquid into the chamber;
a magnetic field source configured to generate an inhomogeneous magnetic field with a vertical magnetic field gradient in the chamber; and
a measuring device configured to detect at least one section of a contour of a drop of the sample liquid formed in the chamber during operation of the measuring assembly.

2. The measuring assembly of claim 1, further including:
an evaluation unit configured to determine significant parameters of the contour from the at least one section of the contour of the drop detected by the measuring device.

3. The measuring assembly of claim 2,
wherein the evaluation unit is further configured to determine the interfacial tension between the carrier liquid and the sample liquid from the significant parameters and magnetic field strengths acting locally on the drop.

4. The measuring assembly of claim 3,
wherein an outlet opening of the supply device positioned inside the chamber is closed off with a capillary.

5. The measuring assembly of claim 1, further including:
a dosing pump connected to an inlet opening of the supply device, wherein the dosing pump is configured to dispense the sample liquid drop by drop into the chamber.

6. The measuring assembly of claim 1,
wherein the measuring device has a radiation source and a radiation sensor, and the vessel is arranged within a beam path between the radiation source and the radiation sensor.

7. The measuring assembly of claim 1,
wherein the measuring device has a plurality of electrodes arranged on the vessel and an impedance measuring device, and the impedance measuring device is configured to determine electrical impedances between two of the electrodes in each case.

8. An apparatus for processing a process liquid, the apparatus comprising:
the measuring assembly of claim 1, wherein the process liquid as the carrier liquid can be supplied to and discharged from the measuring assembly permanently, by user intervention or at predefined time intervals; and
a controllable process device configured to process or use the process liquid, wherein the process device is controllable as a function of the interfacial tension established by the measuring assembly.

9. A measuring assembly for determining interfacial tension, the measuring assembly comprising:
a paramagnetic carrier liquid in a chamber of a vessel;
a magnetic field source configured to generate an inhomogeneous magnetic field with a vertical magnetic field gradient in the chamber;
a drop of a sample liquid in the carrier liquid, wherein the sample liquid is paramagnetic to a lesser degree than the carrier liquid, and the sample liquid and the carrier liquid are immiscible with one another and have different densities; and
a measuring device configured to detect at least section of a contour of the drop.

10. The measuring assembly of claim 9,
wherein the sample liquid contains a diamagnetic liquid.

11. The measuring assembly of claim 9,
wherein the carrier liquid is an aqueous solution and the sample liquid is a hydrophobic liquid.

12. The measuring assembly of claim 9,
wherein the sample liquid is an aqueous solution and the carrier liquid is a hydrophobic liquid.

13. The measuring assembly of claim 9,
wherein the carrier liquid includes an aqueous solution that contains a salt of a rare earth element.

14. A method for determining interfacial tension, the method comprising:
generating a magnetic field, wherein the magnetic field in a chamber of a vessel has a vertical magnetic field gradient;
producing a drop of a sample liquid in the chamber filled with a carrier liquid, wherein the sample liquid is paramagnetic to a lesser degree than the carrier liquid, and wherein the sample liquid and the carrier liquid are immiscible with one another and have different densities; and
detecting significant parameters of the contour of the drop.

15. The method of claim 14, further comprising:
determining the interfacial tension from the significant parameters and magnetic field strengths acting locally on the drop.

16. The method of claim 14, wherein producing the drop comprises:
dispensing a small volume of the sample liquid into the chamber and forming a precursor drop with an initial volume; and
further dispensing the sample liquid into the chamber and coagulating with the precursor drop until the drop resulting from the precursor drop reaches a size at which the contour of the drop fulfills a predetermined criterion.

17. The method of claim 16,
wherein the predetermined criterion is a maximum difference in height of a flat side of the drop across a horizontal minimum surface.
